(19) United States
(12) Patent Application Publication
(10) Pub. No.: US 2015/0093656 A1
(43) Pub. Date: Apr. 2, 2015

(54) Liquid nitrogen battery

(71) Applicant: Scott Clair Pockrandt, Ridgecrest, CA (US)

(72) Inventor: Scott Clair Pockrandt, Ridgecrest, CA (US)

(21) Appl. No.: 13/987,478

(22) Filed: Oct. 1, 2013

(51) Int. Cl. H01M 8/22

(52) U.S. Cl. CPC H01M 8/222
USPC 429/400

(57) ABSTRACT

The Liquid Nitrogen battery uses electrical energy an existing electrical power source to utilize Nitrogen from the atmosphere to generate power, in any form required, to provide continuous, augmented, supplemental or alternate power in any predetermined form, including but not limited to electrical, mechanical and/or hydraulic, which may be produced individually or in any combination.

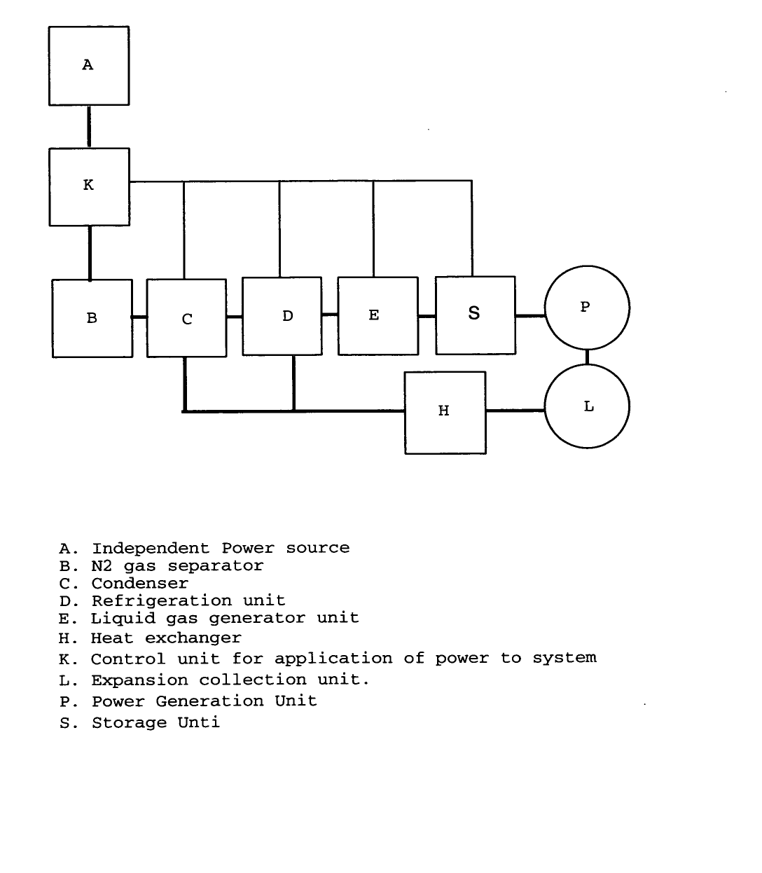

Nitrogen is extracted from the atmosphere, condensed, cooled, stored in liquid form, then expanded to be applied to the generation unit which is selected to provide the type of power needed, allowing reduction of size of source supplying power to this system while maintaining its output, and recycling the expanded Nitrogen gas within the system to provide increased efficiency.

I have developed a process and method which uses the output of an existing electrical power source, in a manner which allows for the storage of said output, and the recovery of that output, to provide for continuous, augmented, alternative and/or supplemental output of power of a predetermined type when required.

The system produces no greenhouse gas emissions. It acts to reduce consumption of any fuels, due to reduced loading on the power generation unit, and increased efficiency due to elimination of conversion losses. When used in combination with passive power sources, it increases efficiency by storing and returning power as well as converting the type of power produced with minimal conversion losses.

When used in combination with new or existing power sources, it increases efficiency by storing and returning power as well as converting the type of power produced with minimal conversion losses. This allows for a reduced size and output of the new or existing power source due to reduced fluctuation of load requirements.

The system operates as a storage system which is not subject to current storage limitations and safety constraints, and which operates without the production of explosive (Hydrogen or other volatile gases) byproducts typically released during charging or discharging of current battery/storage technologies.

The system does not rely on unusual manufacturing processes, or complex parameters which plague existing systems, and which create an additional burden on the environment. Instead, the system uses existing “off the shelf” devices and technologies, but in a new and unique manner, which is not obvious.

The system represents, and is, a renewable technology which in operation will reduce environmental loading of existing private or public power generation plants while increasing efficiency. The system uses Nitrogen, which comprises approximately 80% of the Earth's atmosphere, in a non-consumable manner, and thus represents an environmentally responsible approach to the generation of power.

The application of this process and method, is not a “common usage” or “obvious” use of the materials involved. There is no other system which takes advantage of the properties, methods or materials in this manner.

My original intellectual contributions consist of the configurations and methods needed to accomplish the application of this system. This Application utilizes portions of a previous patent application, Ser. No. 13/694,433, “Liquid Gas Power Generation,” previously filed by me.

### Basic Operation:

Electrical power is applied to the system in order to extract, compress, cool and store Nitrogen in a liquid and/or gaseous form.

This is controlled by a monitoring unit, which determines the amount of liquified gas already stored, the amount in use and the amount necessary to extract from the atmosphere.

Liquid Nitrogen, which is expanded in order to produce power, in any pre-determined form, is collected in an expansion container for recycling within the system, in order to improve efficiency.

### FEDERALLY SPONSORED RESEARCH

Not applicable.

### SEQUENCE LISTING OR PROGRAM

Not applicable.

### BASIC EXPLANATION OF DRAWING 1

The following paragraphs describe the operation of the Liquid Nitrogen Battery (hereinafter referred to as “System”), and explains the drawing.

### DRAWING 1

Power, in the form of electricity, is applied from an existing power generation plant (A), to the System through the Control Unit (K) which regulates the action of, application of power to, and generation of power by, the System. Note that the use of the term “gas” in this paper refers to Nitrogen gas in any physical form, including liquid, gaseous, and others.

Atmospheric Nitrogen gas which comprises approximately 80% of Earth's atmosphere, is separated by the N2 Gas Separator (B).

The Condenser (C) precipitates the Nitrogen, which is then put into liquid form by the Refrigeration Unit (D), and stored for use in Storage Unit (S).

When required and for any duration, including continuous operation, liquid Nitrogen is applied to the Liquid Gas Power Generator Unit (E) which provides the necessary actions to expand the Nitrogen from any physical form, to provide drive in the form of a workable gas to the Power Generation Unit (P), which in turn produces the required amount and form of power to be used, including, but not limited to, mechanical, hydraulic, electrical, or any other form.

The gas which passes through the Power Generation Unit (P), is collected in the Expansion Collection Unit (L), and recycled through a closed system to the Heat Exchanger (H) which is used in combination with Condenser (C), and Refrigeration Unit (D) for re-use in the System.

1. I have developed a process and method for storing and utilizing the output of an existing electrical power source to use Nitrogen in gaseous, liquid and other forms to provide for storage of, and continuous, augmented, alternate and/or supplemental output of, power of any predetermined type, including but not limited to electrical, mechanical and hydraulic, which can be provided individually or in any combination, without consumption of additional fuel, or production of greenhouse gases.
